(19) United States
(12) Patent Application Publication
(10) Pub. No.: US 2019/0346013 A1
(43) Pub. Date: Nov. 14, 2019

(54) ENERGY STORAGE AND POWER OUTPUT FLYWHEEL SYSTEM

(71) Applicants: Daniel Bakholdin, Newbury Park, CA (US); Brij Bhargava, Santa Barbara, CA (US)

(72) Inventors: Daniel Bakholdin, Newbury Park, CA (US); Brij Bhargava, Santa Barbara, CA (US)

(21) Appl. No.: 16/407,089

(22) Filed: May 8, 2019

Related U.S. Application Data
(60) Provisional application No. 62/669,520, filed on May 10, 2018.

(51) Int. Cl. F16F 15/315; F03G 3/08; H02K 7/02; H02K 7/08; H02K 7/09; H02K 21/20; F16C 32/04

(52) U.S. Cl. CPC F16F 15/3156; F03G 3/08; H02K 7/025; F16C 2361/55; H02K 7/09; H02K 21/20; F16C 32/0451; H02K 7/083

(57) ABSTRACT

An improved flywheel system for storing energy and providing the stored energy includes a rotor on a centrally located shaft. The shaft is positioned through support bearings. A magnetic off-loader provides a magnetic force to move the shaft axially in regard to the bearings. A feedback control system, provided to reduce bearing loads on the bearing, comprises a sensor mounted in a bearing housing positioned to measure the distance of a gap between a top end of the shaft and a lower surface of the sensor. In response to changes in the distance the sensor sends an electrical signal to a controller which in turn provides variable electric current to the magnetic off-loader which then provides a magnetic lifting force to the rotor on the shaft to minimize bearing load.

This application claims benefit of U.S. Provisional Application Ser. No. 62/669,520 filed May 10, 2018.

### BACKGROUND

Existing flywheel energy storage systems intended for high power systems (100+ Kw) and short duration (seconds to minutes) delivery of energy primarily utilize complex systems of advanced composite materials and active magnetic bearings to take advantage of high-speed capability (20 krpm and above) and to minimize physical size and the quantity of materials require for their construction. These systems have not yet become low enough in cost to result in wide acceptance and multiple product providers. Where low alloy steels have been utilized for these applications, the steel rotors are large cylinders with thick cross-sections, rather than thin disks, resulting in forgings that require expensive processing and more difficult heat treatment due to the longer time constants involved in heating and quenching thick cross-sections. Non-destructive product inspection is also more difficult, less reliable and more expensive than when the cross-sections are thinner. As a result, these steel alloy wheels have not resulted in lower pricing than the composite counterparts.

The opposite end of the flywheel spectrum, which comprises lower power to energy ratios and where charge and discharge durations are multiple hours, is dominated by low alloy steel rotors that are more economical due to the economies of scale. While rotors in high energy systems have weights typically expressed in tons, the lower energy/high power systems are typically a few hundred pounds. As such, installations of these lower power to energy ratio systems can consist of hundreds of machines, rather than single units or a few dozen units at most as is the case with high power to energy ratio applications. This compounds the economies of scale even farther, considering the large volume of steel required.

Most flywheel designs previously produced utilize permanent magnets and/or electro-magnets to either fully levitate the rotating flywheel mass, where magnetic bearings are used (U.S. Pat. Nos. 5,998,899, 5,864,303), or to “off-load” most of the mass when ball bearings are used, to maximize bearing life and lengthen the time between service intervals (U.S. Pat. No. 9,136,741B2). The axial position measurements of a levitated rotor are critical to systems including levitated rotating assemblies. In cases where magnetics are only utilized to off-load ball bearings (or contact bearings of any sort), force sensors have been used to control off-load using magnetic lift to achieve a preferred bearing load, as measured by the force sensor, such as the load cell shown in U.S. Pat. No. 9,136,741B2. In such a system, small movements can result in large load fluctuations, making it difficult to achieve stable operation at preferred low loads as small deviations in the axial location can result in significant change in the magnitude of the bearing load and as a result preferred load levels are difficult to maintain.

### BRIEF DESCRIPTION

As set forth herein, a preferred embodiment of a flywheel system for providing high power over a short time duration takes advantage of the benefits of low alloy steel, namely high quality and ease of inspection that results from a small cross-section, by employing a thin disk cross-section. A significant portion of the market for high power to energy ratios can be addressed using flywheel rotors constructed of a low alloy steel disc less than 3-inches thick and less than 3 feet in diameter. However, the design improvements described herein are also suitable for use in thicker cross-sections. While the shape of the flywheels used herein do not constitute new matter, as they have been utilized for a considerable period of time, the embodiments addressed herein incorporate new and unobvious peripheral components added to the general flywheel configurations employed in high power, short duration flywheel energy storage systems.

More specifically, the improvements to flywheel systems include, but are not limited to,
a) the inclusion of distance sensors and a magnetic off-loader combined with a feedback control loop, for axially positioning the flywheel disk to minimize bearing loads
b) a stacking system to provide increased power density
c) a unique stator coil arrangement that provides for easy construction of alternative voltage outputs in the finished assembly.

While the feedback control loop is described for use in a flywheel energy storage and motor-generator, preferably in a vertical arrangement, its application is not limited to such systems and is useful in a wide variety of machines that include rotating shaft assemblies in support bearings with the shafts mounted vertically, horizontally or any angular orientation therebetween.

### BRIEF DESCRIPTION OF FIGURES

FIG. 1 is a cross-sectional and cut-away side view of a first embodiment of a flywheel arrangement incorporating features of the invention.

FIG. 2 is an enlarged view of the portion 2 encircled in FIG. 1 showing an embodiment of the shaft and top bearing incorporating features of the invention.

FIG. 3 is a cross-sectional and cut-away side view of a second embodiment of a flywheel arrangement incorporating features of the invention.

FIG. 4 is a front view showing three stacked flywheel units incorporating features of the invention.

FIG. 5 is a top view of the stacked flywheel unit of FIG. 4.

FIG. 6 is a cutaway view showing two parallel windings on a stator to provide a 750V output.

FIG. 7 is a cutaway view showing two coil windings attached in series on a stator to provide a 1500V output.

FIG. 8 is a diagrammatic representation of the feed-back control loop.

### DETAILED DESCRIPTION

### Position Sensing Feedback Control

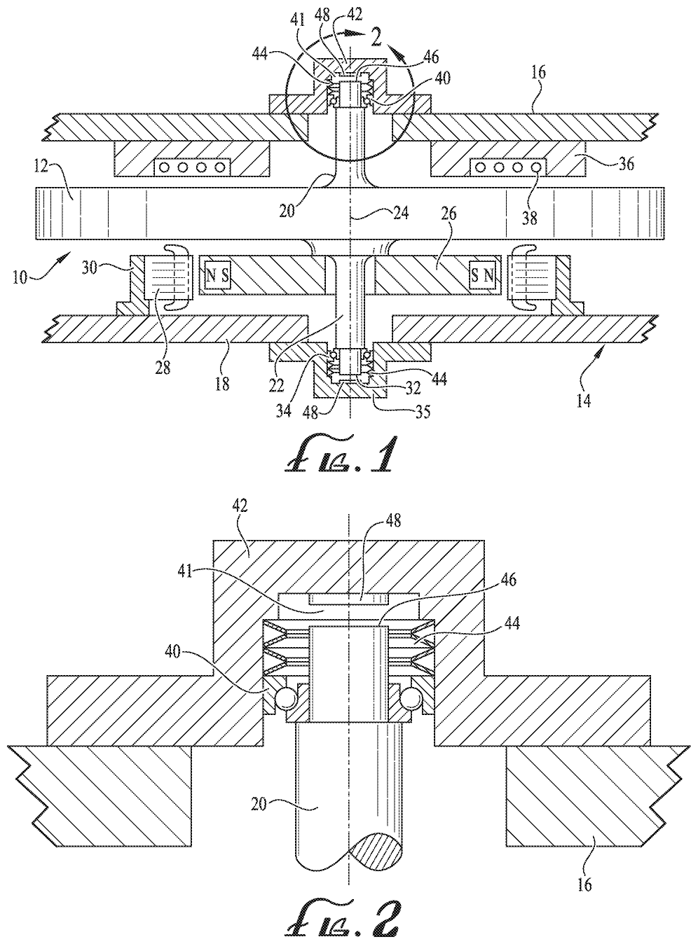

FIG. 1 shows a cut-away view of a flywheel assembly 10 comprising a circular flywheel rotor 12, also referred to as a disc, enclosed in a flywheel housing 14 consisting of an upper housing lid 16 and a housing bottom 18. In preferred embodiments the housing 14 is hermetically sealed and is at a lower pressure then the surrounding ambient condition. An upper shaft 20 and a lower shaft 22 extend vertically above and below the flywheel rotor 12 along a center line 24 through the center of the flywheel rotor 12. The lower shaft 22 extends downward through an opening in the center of a permanent magnet motor generator rotor 26 fixed to the shaft 22 and/or the flywheel 12 so that it rotates with the lower shaft 22 and the flywheel 12. A motor generator stator 28 is fixed to the inner wall of the stator housing 30, said stator housing mounted to the housing bottom 18. The lower end 32 of the lower shaft 22 passes through a lower bearing 34 mounted and supported by a spring assembly 44 in the lower bearing housing 35 to the housing bottom 18. With the compression of the upper spring assembly 44 maintained substantially constant by the control loop discussed herein, the lower spring assembly 44 is sized to provide a predetermined range of bearing preload to accommodate the range of axial length variation in the assembly due to thermal expansion.

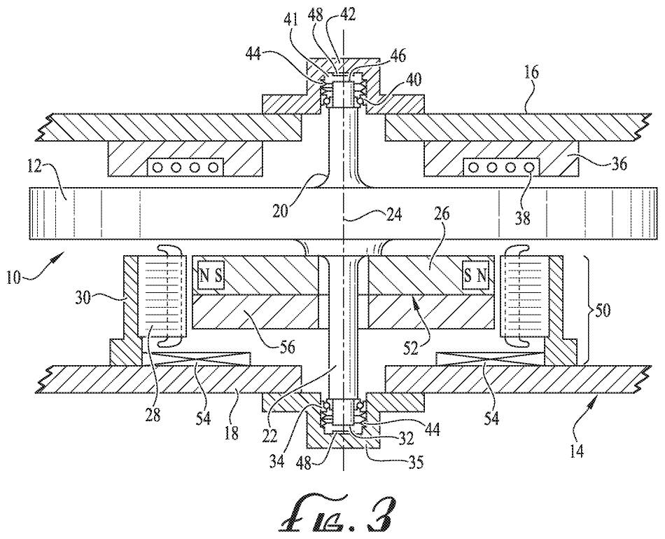

Mounted to a lower (internal) surface of the upper housing is a magnetic off-loader 36. The conductor wire comprising the magnetic coil 38 in the magnetic off-loader 36 is shown as having a round cross-section but can have various different cross-sections such as square or rectangular or be composed of multiple layers of a sheet material. For clarity only four coil turns are shown but numerous turns are generally used. As best shown in FIG. 2, the upper shaft 20 rests in a roller bearing 40 which is moveably positioned (slip-fit) within the upper roller bearing housing 42. While a roller bearing 40 is shown one skilled in the art will recognize that other types of bearings can be used.

Positioned in the upper roller bearing housing 42 above the roller bearing 40 is a spring assembly 44. The spring assembly 44 can be composed of various different spring mechanism, such as a stack (for example 4) of Bellville or conical washers, curved disc washers, split disc washers (such as lock washers), coil springs, etc., the purpose of which is explained below. Also located within the upper roller bearing housing 42 and above the spring assembly 44 a defined distance and spaced from a top end 46 of the upper shaft 20, defining a space 41 or gap, is sensor 48 for measuring or sensing the distance of the top end of the shaft 46 from a lower surface of the sensor 48. The sensor 48 is preferably a capacitive sensor, but may also be an inductive sensor, an optical sensor or other suitable sensor for measuring or sensing changes in the lateral distance in the space or gap 41 between the sensor 48 and the shaft top end.

With reference to FIGS. 1 and 2, by utilizing one or more properly sized, relatively soft springs above the bearing 40 and sensing the position of the shaft end 46 and the dynamic travel thereof allows small fluctuations in the shaft end 46 position to be monitored. A feed-back controller connected between the sensor 48 and the magnetic off-loader 36 processes an electrical signal generated by the sensor and in turn sends a control signal to the electromagnet in the magnetic off-loader 36 to vary the magnetic force applied to the rotor and establish a stable magnetic force control to properly position the location of the rotor 12, and in turn the bearing 40, in relation to the bearing housing 42, which determines compression of spring 44 to provide sufficiently low, preferred bearing loads that in turn result in extended bearing life that can exceed 10 years. With reference to FIG. 8, the feedback control loop 100 controls the current through an electro-magnet in the magnetic off-loader 36 that moves the rotor disk 12 up or down, keeping it in a preferred location determined by use of one or more position sensors. The feedback control system 100 comprising the sensor 48 mounted in the upper bearing housing 42, said sensor 48 measuring the distance of the space or gap 41 between a top end 46 of the upper shaft 20 and a lower surface of the sensor 48, the sensor 48 generating an electrical signal that changes in value in relationship to said distance. The electrical signal from the sensor 48 is processed by the controller 102 which controls the amplitude of electric current through the coil 38 of the electro-magnet within the magnetic off-loader 36.

It should be noted that the embodiment also shows a sensor 48 in the lower bearing housing 35. Various different position sensing technologies, known to those skilled in the art can be utilized. However, capacitive position sensing is preferred due to the stability of operation and the generation of clean electrical signals, even in the presence of large fluctuating magnetic fields range from about 4,000 rpm to about 13,000 rpm.

Capacitive sensors are non-contacting devices capable of high-resolution measurements of changes, in the nanometer range, in the position of a conductive target spaced small distances (referred to as the gap) from the lower surface of the sensor. These devices generate an electrical signal which changes in a defined manner as the distance across the gap varies. For the feedback loop 100, the value of capacitance measured across the gap is correlated to the distance of the sensor face from the rotor surface. The field strength of the lift magnet (the magnetic off-loader 36) in combination with the spring compression is then modulated to change (raise or lower) the location of the rotor adjusting the lateral positions of the rotor to a preferred location to optimize the bearing life.

For high power/short duration operation a single flywheel assembly is typically sized to provide from 100 to 1000 kW for 15 to 30 seconds. While not limiting the scope and operation of the disclosed embodiment, a preferred assembly utilizes a flywheel rotor consisting of a single steel plate, usually up to about 4 inches thick and up to about 48 inches in diameter. In a more preferred embodiment for electric rail transportation applications the rotor is about 2 inches thick and about 32 inches in diameter to provide 100 kW/0.6 kWh (100 kW for 20 second duration) and would have an operating speed range between 4,000 rpm and 13,000 rpm.

By utilizing the combination of relatively low compression, appropriately sized soft springs in the spring assembly 44 located above the upper roller bearing 42, sensing the location, small fluctuations in the location and dynamic travel of the top end 46 of the upper shaft 20, use of a position feed-back control system 100 stabilizes the magnetic force provided by the magnetic off-loader 36 which adjusts the axial position of the rotor 12 in the air gap 41 from about 0.5 mm to 3 mm to provide sufficiently low bearing loads to provide bearing life that can exceed 10 years. In other words, using the feedback control loop 100, the electrical output of the position sensor 48 is fed to a controller 102 which then sends a signal that controls the electrical current through the electro-magnets in the magnetic off-loader 36, adjusting the vertical location of the flywheel rotor 12 up or down, keeping the lateral position of the rotor 12 in a preferred target location to minimize bearing loads. Any one of several position sensing technologies can be utilized.

Using position sensor feedback to control axial shaft position, particularly a capacitive position sensor because they do not provide false data in presence of a magnetic field, the current output from the sensor allows electromagnet control of the magnetic lift force, which in turn determines the shaft axial position, the shaft position determining the magnitude of the compression force provided by the spring assembly in the bearing housing, thus maximizing bearing service life.

### Hybrid Permanent Magnet/Homo-Polar Motor-Generator

For applications where the duty cycle is high, such as when the motor/generator is not coasting and in its energy delivery mode, it is advantageous to utilize the permanent magnet rotor to take advantage of the compact size (less material for cost savings) and high efficiency capability. Such is the case in electric rail energy recycling, which is a primary application of the devices described herein. However, permanent magnet machines have greater coasting losses because the permanent magnetic field causes eddy currents in the surrounding stationary metallic parts, even during coasting. The permanent magnet coasting loss can be avoided using alternative motor types such as Homo Polar, Synchronous Reluctance and Induction Motors.

As an alternative embodiment of the permanent magnet rotor of FIG. 1, a hybrid permanent magnet/homo polar motor-generator arrangement 50 as shown in FIG. 3 can be used. A homo-polar motor generator 52, which includes a homo-polar stator coil 54 adjacent the homo-polar magnet 56, is added adjacent to the permanent magnet motor-generator rotor 26 to form the unique hybrid arrangement 50 in which the size, and coasting losses, are reduced and possibly minimized while still benefitting from the permanent magnet advantages listed above. The homo-polar motor generator 52 is utilized mostly in the lower end of the operating speed range in order to not have to size the permanent motor generator rotor 26 for rated power at lower speeds, which would ordinarily dictate the size requirement of the permanent magnet.

The homo-polar motor-generator 52 can be utilized to boost or buck the field of the permanent magnet motor generator rotor 26. In the boost case, as mentioned above, the homo-polar machine 52 adds to the power output so that the permanent magnet motor generator rotor 26 does not have to be sized for the lowest operating speeds. Another advantage of the presence of the homo-polar motor generator 52 is that it can be used to effectively cancel the field of the rotating permanent magnet when the machine is coasting. This is the case whenever the machine is idling and not motoring or generating. As indicated above, a big disadvantage of permanent magnetic machines in flywheel applications is that the rotating magnetic field produces eddy currents in surrounding stationary electrically conductive material, resulting in drag on the rotating body and lost energy. This lost energy also generates heat, adding to the system heat load and necessitating the use of cooling systems. The controls for the hybrid motor-generator 50 can effectively be utilized to cancel out the field caused by the rotating permanent magnet 26.

The hybrid permanent magnet homo-polar motor generator 50 combination thus increases the overall efficiency of the system that allows reduction of the size and costs of the system and/or provides additional variable load capability. The hybrid combination also avoids the necessity of sizing the permanent magnet alone to achieve power requirements at the lower end of the operating speed range, allowing for a smaller and therefore less expensive permanent magnet component. Minimizing the size of the permanent magnet also minimizes associated coasting losses.

Control of rotating field strength contribution of the homo-polar section 52 can be used to boost and/or add field strength to the field established by the permanent magnet, achieving rated power from a magnet that could not be accomplish otherwise. Controlling the rotating field contribution of the homo-polar section used to buck or cancel some or all of the field strength of the permanent magnet minimizes eddy current coasting losses otherwise caused by the rotating magnetic field of the permanent magnet.

The presence of the permanent magnet section also minimizes the total size required of the homo-polar magnet added to the machine, thus reducing material cost of the homo-polar magnet, which, if used alone is otherwise larger and of lower power density than most other motor-generator types.

### Stackable Units

Typical flywheels that are utilized in electric rail systems have a tall cylindrical configuration, and thus are not suitable for stacking. Because they have higher operating speeds, their footprint provides a higher power density for a single unit. Their length to diameter ratio requires those units to use large cross-section steel forgings or carbon fiber composites resulting in a higher cost than the systems described herein. By stacking the flywheel units 60 (flywheel assembly 10), which have thinner rotating disks (flywheel rotors 12), the power density requirements can be met while maintaining a much lower cost per unit of power ($/MW).

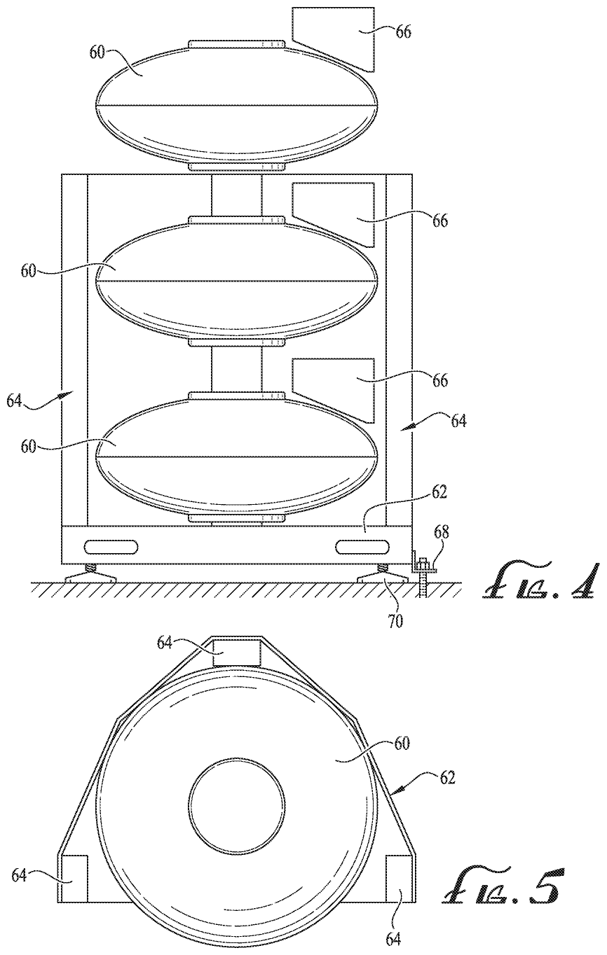

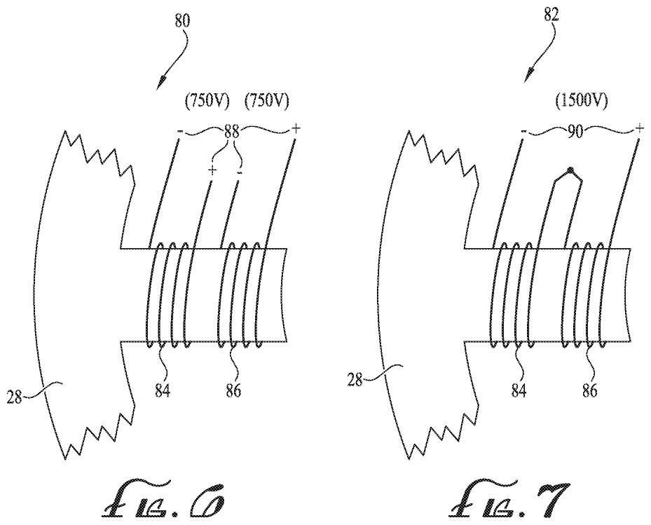

To enable a higher power density footprint, as shown in FIGS. 4 and 5, multiple units 60 are stacked in or on a mounting rack or frame 62, the rack or frame typically a steel structure. However, one skilled in the art will recognize that numerous alternative materials can be used to construct the rack or frame. The rack 62 comprises several vertical posts 64, FIG. 5 showing 3 vertical posts, spaced apart so that the multiple flywheel units 60 can be easily placed therebetween in a stacked configuration. Each unit 60 has its own flywheel power electronics controller 66. The frame 62 once assembled can also be moved in its multiple unit configuration. In a preferred arrangement, three units 60 are stacked in a single frame 62 but other quantities of units 60 can be used, depending on available vertical space.

While it is not novel to stack power units the rack configuration itself provides for stable multi-flywheel operation and ease of loading/maintenance. Flywheel stacking has been suggested in the past; however, implementation has not been successfully applied. The present system, because of its lighter weight and operating stability of the units 60, enables the implementation of stable stacked configurations. Vibration stability can also be maintained by using isolation mounts (not shown) between each of the units 60 or each unit 60 and the posts 64 forming the rack structure, and isolation mounts comprising tension mounts 68 and compression mounts 70, which may also include dampening springs attached to or resting on a supporting floor. The result is dynamic stability, ease of use in loading the units 60 into the frame 62 and mobility of the rack and unit assembly.

### Dual Voltage Stator

Rather than adding expense and complication, while also reducing efficiency by using DC-DC conversion to interface mismatched voltages, for example when a 750 Vdc flywheel system is to be utilized on 1500 Vdc electric rail system, the system shown and described herein allows the flywheel to be configured in various alternative voltage configurations.

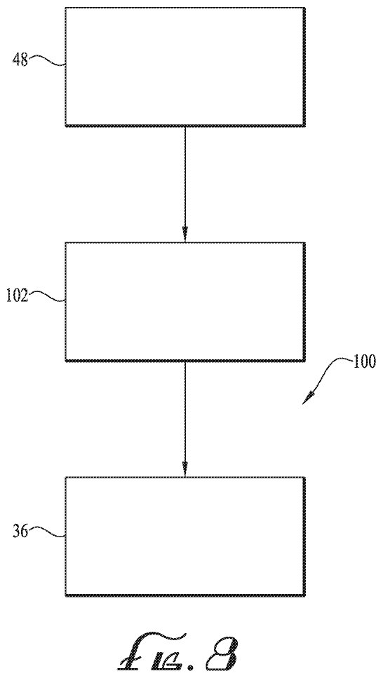

Most flywheels manufactured for world-wide electric metro-train applications are 750 Vdc. However, there is also a growing number of 1500 Vdc systems. With reference to the stator 28, a dual voltage capability is accomplished with stator coil groupings that have separate parallel connections 80 or a serial connection 82 configuration around the iron support portion of the stator, to provide the two separate voltage configurations, for example 750V and 1500V (FIGS. 6 and 7, respectively). This allows for a common coil winding to be partially constructed before assembly of the unit 60. Once the customer specifies the desired output the serial or parallel arrangement can be completed and the assembly completed, thus providing cost advantages at higher volumes. The winding configuration shown allows for a single stocked item to be configured to provide either of two different voltages. As shown in FIG. 6 a first winding 84 and a second winding 86 are mounted adjacent on the stator to provide two separate 750V outputs 88. As shown in FIG. 7 the two adjacent windings can be connected to provide a single 1500 V output 90. However, the alternative coil windings are not limited to 750 and 1500V output and it is not necessary that the series arrangement include 2 equal number of windings, so as to provide a doubling of power output, nor only a pair of windings. One skilled in the art will recognize, based on the teaching herein, that the stator can be assembled with any number of windings in the coil and any number of coils to provide various different voltage outputs.

Throughout this disclosure, the preferred embodiments herein and examples illustrated are provided as exemplars, rather than as limitations on the scope of the present disclosure. As used herein, the terms “invention,” “method,” “system,” “present method,” “present system” or “present invention” refers to any one of the embodiments incorporating features of the invention described herein, and any equivalents. Furthermore, reference to various feature(s) of the “invention,” “method,” “system,” “present method,” “present system,” or “present invention” throughout this document does not mean that all claimed embodiments or methods must include the referenced feature(s).

It is also understood that when an element or feature is referred to as being “on” or “adjacent” another element or feature, it can be directly on or adjacent the other element or feature or intervening elements or features that may also be present. Furthermore, relative terms such as “outer”, “above”, “upper”, “lower”, “below”, and similar terms, may be used herein to describe a relationship of one feature to another. It is understood that these terms are intended to encompass different orientations in addition to the orientation depicted in the figures and do not limit the structures shown to any vertical or horizontal orientation.

Although the terms first, second, etc. may be used herein to describe various elements or components, these elements or components should not be limited by these terms. These terms are only used to distinguish one element or component from another element or component. Thus, a first element or component addressed herein could be termed a second element or component without departing from the teachings of the present invention. As used herein, the term “and/or” includes any and all combinations of one or more of the associated list items.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. For example, when the present specification refers to “a” component or “a” material it is understood that this language, in the first instance, encompasses a single component or a plurality or array of components and, in the second instance, a single or multiple material. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

We claim:

1. An improved flywheel system for storing energy and providing the stored energy comprising:
a. a rotor having a centrally located upper shaft and a centrally located lower shaft mounted thereto, said rotor enclosed in a sealed housing,
b. an upper bearing housing disposed within an upper portion of the housing section and a lower bearing housing disposed within a lower portion of the housing section;
c. an upper bearing located in the upper bearing housing and a lower bearing located in the lower bearing housing, the upper shaft being positioned in the upper bearing and the lower shaft being positioned in the lower bearing, said shafts being moveable axially through a central opening in each of said bearings, and
d. an a magnetic off-loader including an electromagnet configured to provide a magnetic force to move the rotor axially in regard to the upper and lower bearings,
wherein the improvement comprises a feedback control system comprising a sensor mounted in the upper bearing housing, said sensor measuring the distance of a gap between a top end of the upper shaft and a lower surface of the sensor, the sensor generating an electrical signal that changes in value in relationship to said distance, the electrical signal from the sensor processed by a controller, said controller provides variable electric current to the electro-magnet within the magnetic off-loader so as to vary a magnetic lifting force applied to the rotor.

2. The improved flywheel system of claim 1 further including a hybrid motor-generator comprising a permanent magnet motor-generator portion in combination with a homo-polar motor generator portion.

3. The improved flywheel system of claim 1 wherein the rotor is a steel disc with a thickness less than about 3 inches and a diameter of less than about 3 feet.

4. The improved flywheel system of claim 1 further including a stator winding configured to be converted between parallel windings and series windings.

5. The improved flywheel system of claim 4 wherein the parallel windings provide a first voltage output and the series windings provide a second voltage output greater than the first voltage output.

6. A flywheel system for storing energy and providing the stored energy comprising multiple flywheel units, the multiple units stacked vertically within a mounting frame, each unit comprising
a. a rotor having a centrally located upper shaft and a centrally located lower shaft mounted thereto, said rotor enclosed in a sealed housing,
b. an upper bearing housing disposed within an upper portion of the housing section and a lower bearing housing disposed within a lower portion of the housing section;
c. an upper bearing located in the upper bearing housing and a lower bearing located in the lower bearing housing, the upper shaft being positioned in the upper bearing and the lower shaft being positioned in the lower bearing, said shafts being moveable axially through a central opening in each of said bearings, and
d. a magnetic off-loader including an electromagnet configured to provide a magnetic force to move the rotor axially in regard to the upper and lower bearings, and
e. a feedback control system comprising
i. a sensor mounted in the upper bearing housing, said sensor measuring the distance of a gap between a top end of the upper shaft and a lower surface of the sensor, the sensor generating an electrical signal that changes in value in relationship to said distance,
ii. the electrical signal from the sensor processed by a controller, said controller sending an electric current to the electromagnet within the magnetic off-loader so as to vary a magnetic force applied to the rotor so as to move the rotor axially.

7. A system for minimizing bearing load in an apparatus having a rotating assembly including a shaft, said shaft having first and second spaced apart portions thereof passing through central axial openings in the first and second bearings, said system comprising:
a. said first bearing located in a first bearing housing and the second bearing located in a second bearing housing, the first portion of the shaft being positioned in the opening in the first bearing and the second portion of the shaft being positioned in the opening in the second bearing, said shaft being moveable axially through said first and second central openings in each of said bearings, and
b. a magnetic off-loader including an electromagnet configured to provide a magnetic force to move the rotating assembly axially in regard to the first and second bearings, and
c. a feedback control system comprising
i. a sensor mounted in the first bearing housing, said sensor measuring the distance of a gap between a first end of the shaft and a sensing surface of the sensor, the sensor generating and electrical signal that changes in value in relationship to said distance,
ii. the electrical signal from the sensor processed by a controller, said controller sending an electric current to an electromagnet within the magnetic off-loader so as to vary the magnetic force applied to the rotating assembly and to move the rotating assembly axially in relationship to the first and second bearing.
